(19) United States
(12) Patent Application Publication
(10) Pub. No.: US 2010/0171358 A1
(43) Pub. Date: Jul. 8, 2010

(54) SUPPORT WRAP ASSEMBLY

(76) Inventor: Jennifer Hull, La Canada, CA (US)

Correspondence Address: TSIRCOU INTELLECTUAL PROPERTY LAW, 655 Central Ave., 17th Floor, Glendale, CA, 91203, US

(21) Appl. No.: 12/624,167

(22) Filed: Nov. 23, 2009

Related U.S. Application Data
(60) Provisional application No. 61/117,051, filed on Nov. 21, 2008.

(51) Int. Cl. A62B 35/00; B60R 22/12; B60R 22/00

(52) U.S. Cl. 297/481

(57) ABSTRACT

A support wrap is provided that wraps around a person and the object they are sitting in or standing in to secure them in the sitting and standing position, as well as various other positions. The support wrap includes a body and fasteners disposed at opposing ends of the body.

### CROSS REFERENCE TO RELATED APPLICATION

This application claims priority to U.S. provisional application No. 61/117,051, filed Nov. 21, 2009, which is incorporated by reference.

### FIELD OF THE INVENTION

The present invention relates generally to support straps and, more particularly, to support straps configured to provide support for individuals.

### BACKGROUND OF THE INVENTION

There are people of all ages that have a difficulty sitting and/or standing independently for various reasons. For example, babies and younger toddlers need extra support while sitting in a chair, sitting in a chair while on a booster seat, sitting in a grocery cart, sitting in a high chair, or sitting on a ride toy. Babies and toddlers tend to stand in certain situations like in a chair, high chair or in a grocery cart that would potentially result in bodily harm if they were to fall.

In addition, there are many special needs children, teens, and adults with medical problems that hinder them from sitting and/or standing independently that have difficulty standing in physical and occupational therapy devices. For example, many wheelchair bound people have trouble maintaining a sitting position. They require additional support to help them maintain their position, especially to allow the individual to have some independence and to participate in regular activities.

It should, therefore, be appreciated that there remains a tremendous need for a support wrap that addresses the aforementioned shortcomings. The present invention fulfills these needs and others.

### SUMMARY OF THE INVENTION

Briefly, and in general terms, the invention provides a support wrap that wraps around a person and the object they are sitting in or standing in to secure them in the sitting and standing position, as well as various other positions. The support wrap includes a body and fasteners disposed at opposing ends of the body.

The support wrap can help secure and balance muscle reaction and disbursement for the demands of many individuals, particularly special needs and geriatrics, with varying muscle growth development or degeneration. The support wrap can be used to provide immediate support and comfort solutions for emergent medical situations such as a stroke, heart attack, head injury, particularly traumatic brain injury, or any scenario resulting in sudden changes and control of bodily functions whereby appropriate medical equipment is not directly available, timely or simply does not exist.

More particularly, by way of example and not limitation, the support wrap can be used to wrap around the torso of a user and around a back support of a seat, e.g., a high chair, wheelchair, grocery cart, ride toy with backing, other physical or occupational therapy devices. The support wrap can also be used as an additional supportive strap to secure them to a physical and occupational therapy device used for standing.

In an exemplary use in accordance with the invention, the support wrap can be used to help prevent injury, this mobile and compact wrap provides controlled and secure support for various brain and physical debilitations resulting from a large range of diseases, disorders and medical conditions, such as dementia and Alzheimer's in which sitting muscles are often not naturally or instinctively activated and result in physical impairment and harm.

In another exemplary use in accordance with the invention, the support wrap can be used to provide maximum support, security, and cost efficiency for the short-term and permanent use of the numerous assistive medical devices such as wheel chairs, walkers, and standers, which frequently lack basic support and security components and rarely facilitate additional assistive devices.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein. Moreover, a number of features are discussed throughout the specification with reference to particular embodiments. Nonetheless, those skilled in the art will appreciate that various other embodiments can be provided without departing from the scope of the invention, to include any and all combination of features discussed.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1A is a front perspective view of a first embodiment of a support wrap in accordance with the present invention.

FIG. 1B is a back perspective view of the support wrap of FIG. 1.

FIG. 2 is a front perspective view of the support wrap of FIG. 1, depicted in a closed configuration.

FIG. 3 is a perspective view of a second embodiment of a support wrap in accordance with the present invention, depicting two secondary straps and buckles attached to an upper edge.

FIG. 4 is a back perspective view of the support wrap of FIG. 3, depicting the two secondary aiding in support over the back of a stationary object such a chair.

FIG. 5 is a close-up view of a view of a pocket on the support wraps of FIG. 1A and FIG. 3A, the pocket can be used to store the assembly when rolled up.

FIG. 6 depicts an exemplary use of a support wrap in accordance with the present invention, depicting the support wrap about the torso of a user and continuing around the back of a wheelchair.

FIG. 7 depicts an exemplary use of a support wrap in accordance with the present invention, depicting the support wrap about the torso of a user and continuing around the back of a shopping cart.

FIG. 8 is a perspective view of a third embodiment of a support wrap in accordance with the present invention, depicting a double buckle configuration.

FIG. 9 depicts an exemplary use of a support wrap of FIG. 8, depicting the support wrap about the torso of a user and continuing around the back of a wheelchair.

FIG. 10 depicts a support wrap in accordance with the present invention rolled into its pocket (see FIG. 5) and disposed in a purse.

FIG. 11 is a back perspective view of a third embodiment of a support wrap in accordance with the present invention.

FIG. 12 depicts an exemplary use of a support wrap of FIG. 8, depicting the support wrap about the torso of a user and continuing around the back of a chair.

FIG. 13 depicts an exemplary use of a support wrap in accordance with the present invention, depicting the support wrap about the legs of a user and continuing around a support of a wheelchair.

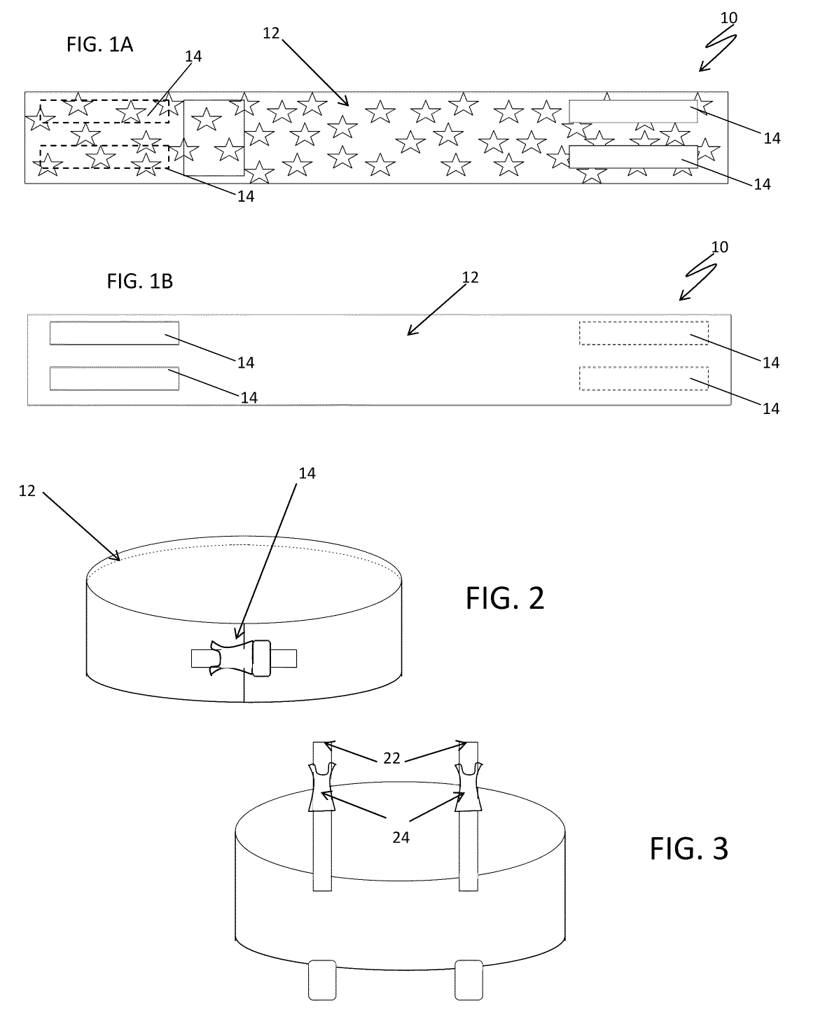

### DETAILED DESCRIPTION OF THE PREFERRED EMBODIMENTS

Referring now to the drawings, there is shown a support wrap 10 configured to provide support to an individual, particularly when seated. The support wrap includes a body 12 and fasteners 14 disposed at opposing ends of the body. In use, the support wrap can be used to wrap around the torso of a user and around a back support of a seat, e.g., a high chair, wheelchair, occupational therapy devices, and so on.

The support wrap 10 is particularly effective for individuals having special needs. Certain special-needs individuals can have difficulty performing basic functions such as sitting or standing. The support wrap aids such individuals, in that it can secure the individual to a support to protect against injury. In addition, the support wrap can provide an external cue that can trigger the autonomic reflexes, causing appropriate muscle reactions for stabilizing the torso. As a result, the support wrap can serve dual roles as a safety if there was something that offered an additional cue to them, they would be more successful at maintaining an upright and seated position. The wrap would be able to provide the additional support and cues that all individuals need that have trouble with various sitting and standing positions for whatever circumstance they have that prevent them from having full bodily control.

In the exemplary embodiment, the body 12 is formed of two layers of durable fabric material, forming a generally elongated rectangular shape. The body can be provided in other shapes without departing from the invention, e.g., crescent. The fabric is sufficiently sturdy to support an individual, while having sufficient flexibility as to ensure a certain level of comfort. In an exemplary embodiment, at least one layer of material is relatively sturdy, e.g., corduroy, sunbrella material, neoprene, and various reinforced materials. Additional materials can be used to provide a pleasing feel such as, e.g., cotton, wool, linen, taffeta, silk, terry cloth, spandex, vinyl, muslin, and velvet. In addition, ribbing can be used at selected locations about the body to aid in bracing the user. Elastic material can also be provided at selected locations about the body.

The body can be provided in different sizes. For example, in a first configuration, the body can have a length of about 50 inches a width of about 6 inches, e.g., for use with children. In a second configuration, the body can have a length of about 60 inches a width of about 8 inches, e.g., for use adults.

In the exemplary embodiment, the fasteners 14 are configured as elongated strips of hook-and-loop material, e.g., as provided by Velcro USA, Inc., of Manchester N.H., under the brand name Velcro®. Two pairs of fastener strips are disposed at opposing ends of the body 12. The strips extend from the opposing ends generally parallel to a longitudinal axis of the body approximately ⅓ the overall length of the body. As a result, the support can be adjusted for use in a variety of circumstances. In other embodiment, other fasteners can be provided, as supplement to or instead of the elongated strips, e.g., such as buckles, snaps, buttons, zippers, hook and eye, clasps, ribbon, and ties, to name a few.

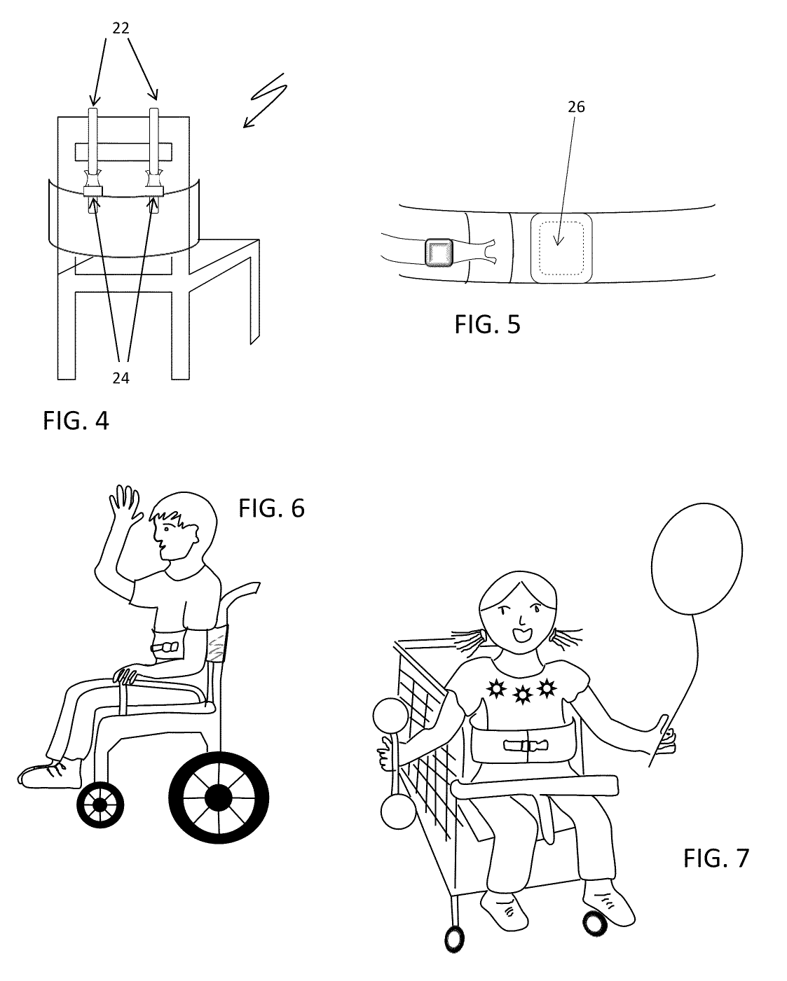

In other embodiments, the support wrap can include additional strap extending from the body to aid in securing the individual. For example, FIGS. 3 and 4 depict a support wrap 20 having attachment straps 22 extending from an intermediate region of the body. The attachment straps are configured to couple to buckles 24 located in the intermediate region, spaced from the attachment straps. The straps can be used to aid in securing the individual to a support device. For example, as shown in FIG. 4, the attachment straps can extend around the back of a chair and coupled to the buckles, to aid in securing the individual (not shown) in place.

With reference now to FIG. 5, support wraps in accordance with the invention can further include a pocket 26 proximate to an end of the body. The support wrap can be rolled up and placed in the pocket for compact storage. For example, FIG. 10 depicts a support wrap rolled into its pocket (see FIG. 5) and disposed in a purse.

FIGS. 6 and 7 depict exemplary uses of a support wrap in accordance with the present invention. For example, FIG. 6 depicts the support wrap about the torso of a user and continuing around the back of a wheelchair. In FIG. 7, the support wrap about the torso of a user and continuing around the back of a shopping cart.

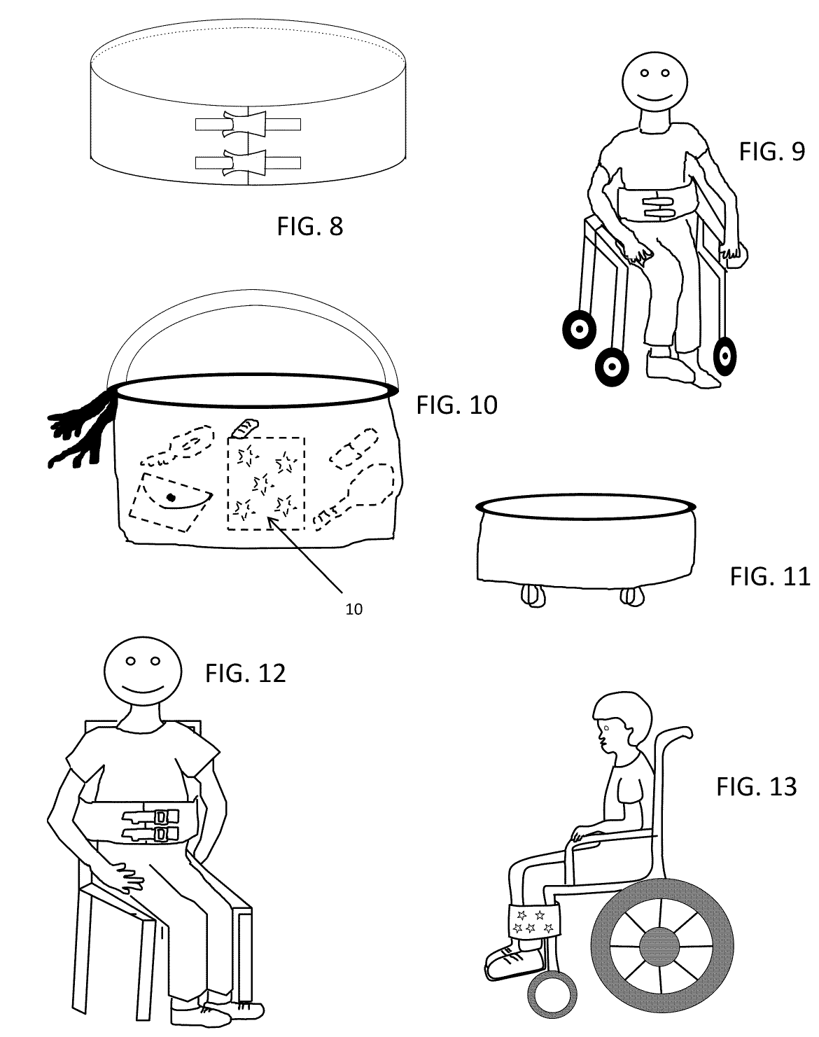

FIG. 8 depicts another exemplary embodiment of a support strap in accordance with the invention. The support wrap includes a double buckle configuration for securing the wrap in place. Exemplary uses are depicted in FIGS. 9 and 12. FIG. 9 depicts the support wrap about the torso of a user and continuing around the back of a wheelchair. In FIG. 12, the support wrap extends about the torso of a user and continuing around the back of a chair.

Support wraps in accordance with the present invention can be used in various other applications. For example, as shown in FIG. 13, the support wrap is disposed about the legs of a user and continuing around a support of a wheelchair.

Although the invention has been disclosed in detail with reference only to the exemplary embodiments, those skilled in the art will appreciate that various other embodiments can be provided without departing from the scope of the invention, to include any and all combination of features discussed. Accordingly, the invention is defined only by the claims set forth below.

What is claimed is:

1. A support wrap assembly, comprising:
an elongated body of sufficient length to wrap around a torso of a user and around a back support of a support device;
an attachment strap extending from an intermediate region of the elongated body; and
a pocket proximate to an end of the body, such that the support wrap can be rolled up an placed in the pocket for storage.

2. A support wrap assembly as defined in claim 1, further comprising a secondary strap configured to extend over an upper edge back of a chair and coupled to buckles attached to the elongated body, to aid in securing the individual in place.

3. A support wrap assembly as defined in claim 1, wherein the support device is selected from a group consisting of a chair, wheelchair, and occupational therapy device.

4. A support wrap assembly as defined in claim 1, wherein the elongated body having a prescribed shape selected from a group consisting of a rectangular or crescent.

5. A support wrap assembly as defined in claim 1, wherein the elongated body comprising two layers of material.

6. A support wrap assembly as defined in claim 1, wherein the attachment strap is configured to couple to buckles spaced from the attachment strap.

7. A support wrap assembly, comprising:
an elongated body of sufficient length to wrap around a torso of a user and around a back support of a support device;
an attachment strap extending from an intermediate region of the elongated body; and
a secondary strap configured to extend over an upper edge back of a chair and coupled to buckles attached to the elongated body, to aid in securing the individual in place.

8. A support wrap assembly as defined in claim 7, wherein the support device is selected from a group consisting of a chair, wheelchair, and occupational therapy device.

9. A support wrap assembly as defined in claim 7, wherein the elongated body having a prescribed shape selected from a group consisting of a rectangular or crescent.

10. A support wrap assembly as defined in claim 7, wherein the elongated body comprising two layers of material.

11. A support wrap assembly as defined in claim 7, wherein the attachment strap is configured to couple to buckles spaced from the attachment strap.

12. A support wrap assembly, comprising:
an elongated body of sufficient length to wrap around a torso of a user and around a back support of a support device;
an attachment strap extending from an intermediate region of the elongated body;
a secondary strap configured to extend over an upper edge back of a chair and coupled to buckles attached to the elongated body, to aid in securing the individual in place; and
a pocket proximate to an end of the body, such that the support wrap can be rolled up an placed in the pocket for storage.

13. A support wrap assembly as defined in claim 12, wherein the support device is selected from a group consisting of a chair, wheelchair, and occupational therapy device.

14. A support wrap assembly as defined in claim 12, wherein the elongated body having a prescribed shape selected from a group consisting of a rectangular or crescent.

15. A support wrap assembly as defined in claim 12, wherein the elongated body comprising two layers of material.

16. A support wrap assembly as defined in claim 12, wherein the attachment strap is configured to couple to buckles spaced from the attachment strap.
